(19) United States
(12) Patent Application Publication
(10) Pub. No.: US 2003/0172901 A1
(43) Pub. Date: Sep. 18, 2003

(54) Method, computer program and control device and/or regulating device for operating an internal combustion engine

(76) Inventors: Klaus Joos, Walheim (DE); Andreas Roth, Muehlacker (DE); Gerd Grass, Schwieberdingen (DE); Ruediger Weiss, Moetzingen (DE); Edmund Schaut, Friolzheim (DE); Ulrich Hipp, Tamm (DE); Manfred Haendle, Siegelhausen (DE)

Correspondence Address: WALTER OTTESEN, Patent Attorney, P O Box 4026, Gaithersburg, MD, 20885-4026, US

(21) Appl. No.: 10/344,746

(22) PCT Filed: Jul. 20, 2001
(86) PCT No.: PCT/DE01/02744

(30) Foreign Application Priority Data
Aug. 14, 2000 (DE) 100 40 252.6

(51) Int. Cl. F02B 17/00

(52) U.S. Cl. 123/295; 123/399; 123/305

(57) ABSTRACT

Fuel is injected directly into at least one combustion chamber (12) in a method for operating an internal combustion engine (10), especially for a motor vehicle. Furthermore, air is supplied to the combustion chamber (12) via an intake manifold (14). Injection and supply take place at least from time to time so that the mixture of fuel and air in the combustion chamber (12) is stratified. Furthermore, a temperature (tmot) is determined which is specific for the internal combustion engine (10). The pressure (pss) in the intake manifold (14) is changed in dependence upon the determined temperature (tmot) in order to guarantee an optimal operating performance of the internal combustion engine (10) in all operating ranges of the engine (10).

### STATE OF THE ART

The present invention relates to a method for operating an internal combustion engine, especially for a motor vehicle, wherein the fuel is at least from time to time so injected into at least one combustion chamber and air is at least from time to time so supplied to the combustion chamber via an intake manifold that the mixture of fuel and air is stratified in the combustion chamber. In the method, a temperature is determined which is specific for the internal combustion engine.

A method of this kind is known from the marketplace and is generally identified as GDI stratified operation (GDI=gasoline direct injection). In such a method, the mixture is enriched in the region of a spark plug, which is mounted in the combustion chamber of the engine, to the extent that a reliable ignition is guaranteed. The combustion in the remaining combustion chamber takes place, however, in average for a greatly leaned mixture, that is, with a clear excess of oxygen. Accordingly, layers having different air/fuel ratios are present in the combustion chamber.

In the known method, it has however been shown that for cold engines, the operating performance in stratified operation differs clearly from that in warm engines and is not always optimal.

The present invention therefore has the task to optimize the operating performance of the internal combustion engine in stratified operation for cold and warm engines.

This task is solved in that the pressure in the intake manifold is changed in dependence upon the determined temperature for the method mentioned initially herein.

The vaporization behavior of the fuel in the combustion chamber was identified as a significant cause for the temperature-dependent driving performance of an internal combustion engine operated in stratified operation. The better and more rapidly the fuel vaporizes and the smaller the vapor droplets of the fuel are, the better, that is, the more uniformly does the combustion take place.

The vaporization characteristics of the fuel are, however, dependent, inter alia, on the temperature: for a cold temperature of the engine, the inducted air in the combustion chamber is relatively cold and this makes the optimal vaporization of the fuel difficult. Oppositely, for a warm engine, the air is relatively warm and this improves the vaporization of the fuel.

According to the invention, it was recognized that the vaporization of the fuel is dependent not only on the temperature but also on the pressure of the inducted air. For a lower pressure, and especially at cold temperatures of the engine, a better vaporization of the injected fuel takes place. Oppositely, a high pressure in the intake manifold can also be permissible at a high specific temperature of the engine without the operating performance of the engine deteriorating because of this. The measure of the invention to change the pressure in the intake manifold in dependence upon the determined temperature makes it therefore possible to make available in each temperature range of the engine the pressure ratios needed for an optimal vaporization of the fuel.

With the measure of the invention, the smooth running of the engine in the cold operating state is, inter alia, improved. Also, less toxic substances are emitted. In addition, higher exhaust-gas temperatures occur which are advantageous for heating up the pre-catalytic converter. Notwithstanding the throttling in the stratified operation, the intake manifold pressure is always still higher than for the homogeneous operation. Inter alia, a savings in fuel is thereby also possible.

Advantageous further embodiments of the invention are set forth in the dependent claims.

For determining the temperature, which is specific for the engine, especially fluids are suitable which are guided through the engine or past the engine during the operation thereof. For this reason, a method of the invention is advantageous wherein the temperature of a fluid, which is warmed during operation of the engine, is determined. The fluids are especially the cooling water and/or cooling air and/or oil. The temperature of these fluids lies in a range which can be detected with relatively cost-effective sensors. Furthermore, these fluids react relatively rapidly to changes of the temperature of the engine, that is, for example, of the engine block, so that the actual operating state of the engine can be determined without delay.

In a further embodiment of the invention, it is also suggested that the determined temperature be compared to a limit value and the pressure in the intake manifold be reduced when there is a drop below the limit value. With this measure of the invention, the operating performance in stratified operation is, for example, improved shortly after the start of the engine when the specific temperature thereof is still relatively low.

In the same way, the suggestion is made according to the invention that the temperature be compared to a limit value and, when this limit value is exceeded, the pressure in the intake manifold is increased. In this way, it is ensured that the engine is dethrottled when the engine reaches its normal operating temperature in order to be able to maximize the advantages, which are achievable during operation of an internal combustion engine having gasoline direct injection. These advantages are, for example, minimum fuel consumption and low emissions of toxic substances.

The change of the pressure in the intake manifold takes place preferably via a change in the cross section of at least one region of the intake manifold, especially, via an angle change of a throttle flap. This is a well known and simple way to change the pressure in the intake manifold. Under some circumstances, however, valves can also be provided which connect intake pipes, which have different lengths and/or different diameters, to the combustion chamber, depending upon the desired pressure.

In many internal combustion engines, the pressure in the intake manifold is not only a relevant parameter for the operation of the engine itself but it can also depend on different influence quantities. Thus, a brake amplifier of a vehicle is operated at underpressure which, for example, must be made available by the intake manifold.

In order to be able to actually make available the underpressure required for braking, it can therefore be necessary to lower the pressure in the intake manifold to a value which would normally not be necessary for the optimal operating performance of the engine. Finally, in this method, the pressure in the intake manifold is therefore additionally changed in dependence upon other influence quantities, especially in dependence upon a pressure input of a brake underpressure control, and in such a manner that the smallest desired pressure is adjusted in each case.

In lieu of or in addition to a pressure change on the basis of limit values, this pressure change can also take place in dependence upon a characteristic line.

In a further embodiment of the method of the invention it is finally suggested that the pressure in the intake manifold be changed in dependence upon a characteristic field formed from the temperature and a relative fuel mass. This further embodiment of the method of the invention is based on the realization that the operating performance of the internal combustion engine depends not only on a specific temperature of the engine but also the relative fuel mass injected into the combustion chamber in correspondence to the power or torque request of the user.

The effects of a deteriorated vaporization of the injected fuel are more clear for a low quantity of injected fuel than for a large injected fuel mass. This is taken into account by the corresponding characteristic field. If needed, the characteristic field could also include the position of the accelerator pedal and/or the rpm of the crankshaft of the engine.

The invention relates also to a computer program which is suitable for carrying out the above method when it is executed on a computer. It is especially preferred when the computer program is stored in a memory, especially in a flash memory.

The invention relates finally to a control arrangement (open loop and/or closed loop) for operating an internal combustion engine, especially for a motor vehicle, where fuel is so injected at least from time to time into at least one combustion chamber and air is at least from time to time so supplied to the combustion chamber via an intake manifold that the mixture of fuel and air is stratified in the combustion chamber. The control arrangement includes means for determining a temperature specific for the internal combustion engine.

In order to optimize the operating performance in all specific temperature ranges of the internal combustion engine, the invention suggests that the control arrangement (open loop and/or closed loop) include means which change a desired value for the pressure in the intake manifold in dependence upon the determined temperature. Alternatively, it can be provided that the control arrangement (open loop and/or closed loop) include means which change a desired value for the position of a throttle flap in the intake manifold in dependence upon the determined temperature.

In the following, an embodiment of the invention will be explained in greater detail with reference to the accompanying drawing. In the drawing:

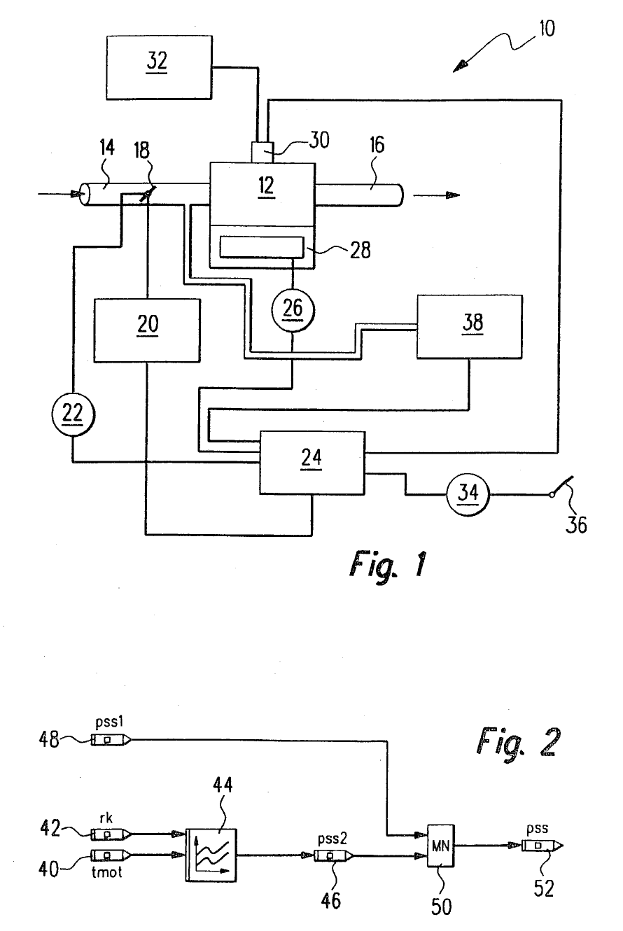

FIG. 1 shows a block circuit diagram of an internal combustion engine; and,

FIG. 2 shows a schematic flowchart of a method for operating the internal combustion engine of FIG. 1.

In FIG. 1, an internal combustion engine as a whole is identified by reference numeral 10. The engine includes a combustion chamber 12 to which air is supplied via an intake manifold 14. The exhaust gases are directed away via an exhaust-gas pipe 16.

The pressure in that region of the intake manifold, which lies directly ahead of the combustion chamber 12, is adjusted by the position of a throttle flap 18 whose angular position can be changed by an actuating motor 20. The position of the throttle flap 18 is detected by a position transducer 22 and is transmitted to a control arrangement 24. The control arrangement 24 also receives signals from a temperature sensor 26, which taps the temperature of the water of the cooling water loop 28.

Fuel is injected into the combustion chamber 12 via a valve 30 and this fuel is supplied to the valve 30 from a fuel tank 32. The injection valve 30 is driven by the control arrangement 24 in dependence upon the position of the accelerator pedal 36 detected by the position transducer 34.

Finally, a brake system 38 is present which is likewise connected via signals to the control arrangement 24. The brake system 38 is pneumatically connected to the region of the intake manifold 14 lying between the throttle flap 18 and the combustion chamber 12.

The operation of the internal combustion engine 10 is hereinafter explained with reference to FIG. 2. The method shown in FIG. 2 is stored as a computer program on a flash memory (not shown) of the control arrangement 24.

Three input variables are the basis of the method, namely, the temperature tmot (block 40) of the cooling water which is made available by the temperature sensor 26 with this temperature being a temperature specific for the engine 10. A further input quantity is the relative fuel mass rk (block 42) which is that fuel mass which is injected into the combustion chamber 12 via the injection valve 30. The fuel mass rk is determined in dependence upon the position of the accelerator pedal 36 detected by the position transducer 34, that is, it is dependent upon the power or torque request of the user.

The two input quantities rk and tmot are compared in block 44 to a characteristic field stored in a memory of the control arrangement 24 and a desired value pss2 (block 46) is determined for the pressure in the intake manifold 14. This desired value pss2 corresponds to the position in the characteristic field.

Parallel to the above, a desired value pss1 for the pressure in the intake manifold 14, which is dependent upon the brake system 38, is determined in the control arrangement 24. For an actuation of a brake pedal (not shown in FIG. 1), an underpressure is requested, for example, by the braking force amplifier of the brake system 34 and this underpressure must be made available by the intake manifold 14. This underpressure corresponds to the desired value pss1 in the block 48 of the flow diagram of FIG. 2. The two desired values pss1 (block 48) and pss2 (block 46) for the pressure in the intake manifold 14 are fed into a minimum value former 50 which outputs the smaller of the two values as desired value pss (block 52) for the pressure in the intake manifold 14.

The actuating motor 20 of the throttle flap 18 is driven by the control arrangement 24 in correspondence to the desired value pss (block 52). The position of the throttle flap 18 is fed back again to the control arrangement 24 via the position transducer 22 in the sense of a closed control loop. The position of the throttle flap 18 is used by the control arrangement 24 in order to model the pressure present in the intake manifold 14. In this way, it is possible to convert the desired value pss (block 52) for the pressure in the intake manifold 14 into a position of the throttle flap 18. Alternatively, however, a pressure sensor can also be provided in the intake manifold which conducts a signal, which corresponds to the pressure in the intake manifold, directly to the control arrangement 24.

When the temperature sensor 26 determines a temperature tmot of the cooling water circulating in the loop 28 which is viewed as being relatively low, a relatively low desired pressure pss2 is determined via the characteristic field (block 44). Correspondingly, the throttle flap 18 is so driven by the control arrangement 24 that the cross section of the intake manifold 14 becomes narrower and therefore the pressure, which is present between the throttle flap 18 and the combustion chamber 12 in the intake manifold 14, is lower. In this way, also when the engine 10 is still cold (that is, shortly after the start of the engine 10), a vaporization of the fuel in the combustion chamber 12 is guaranteed which is sufficient for carrying out the stratified operation.

Otherwise, in lieu of the characteristic field in block 44, a comparison to one or several limit values can be carried out. The use of a characteristic line is also possible. In this case, no consideration of the fuel mass would take place.

1. Method for operating an internal combustion engine (10), especially for a motor vehicle, wherein fuel is at least from time to time so injected into at least one combustion chamber (12) and air is so supplied at least from time to time via an intake manifold (14) that the mixture of fuel and air in the combustion chamber (12) is stratified and, wherein a temperature (tmot), which is specific for the engine (10), is determined, characterized in that the pressure (pss) in the intake manifold (14) is changed in dependence upon the determined temperature (tmot).

2. Method of claim 1, characterized in that the temperature (tmot) of a fluid, especially of cooling water (28) and/or cooling air and/or oil is determined, the fluid being warmed during the operation of the engine (10).

3. Method of one of the claims 1 or 2, characterized in that the determined temperature is compared to a limit value and the pressure in the intake manifold is reduced when there is a drop below the limit value.

4. Method of one of the above claims, characterized in that the temperature is compared to a limit value and the pressure in the intake manifold is increased when the limit value is exceeded.

5. Method of one of the above claims, characterized in that the change of pressure (pss) in the intake manifold (14) takes place via a change in cross section of at least a region of the intake manifold (14), especially via an angle change of the throttle flap (18).

6. Method of one of the above claims, characterized in that the pressure (pss) in the intake manifold (14) is changed additionally in dependence upon other influence quantities, especially in dependence upon the pressure input (pss1) of a brake underpressure control (38), in such a manner that the smallest desired pressure is adjusted in each case.

7. Method of one of the above claims, characterized in that the pressure in the intake manifold is changed in dependence upon a temperature characteristic line.

8. Method of one of the above claims, characterized in that the pressure (pss) in the intake manifold (14) is changed in dependence upon a characteristic field (44) formed from the temperature (tmot) and a relative fuel mass (rk).

9. Computer program characterized in that it is suitable for carrying out the method of one of the claims 1 to 8 when executed on a computer.

10. Computer program of claim 9, characterized in that it is stored in a memory, especially in a flash memory.

11. Control arrangement (open loop and/or closed loop) for operating an internal combustion engine (10), especially for a motor vehicle, wherein fuel is so injected at least from time to time directly into at least one combustion chamber (12) and air is so supplied at least from time to time via an intake manifold (14) that the mixture of fuel and air in the combustion chamber (12) is stratified; means (26) for determining a temperature (tmot), which is specific for the internal combustion engine (10), characterized in that the control arrangement includes means which change a desired value (pss) for the pressure in the intake manifold (14) in dependence upon the determined temperature (tmot).

12. Control arrangement (open loop and/or closed loop) for operating an internal combustion engine (10), especially for a motor vehicle, wherein fuel is so injected at least from time to time into at least one combustion chamber (12) and air is so supplied at least from time to time via an intake manifold (14) that the mixture of fuel and air in the combustion chamber (12) is stratified; means (26) for determining a temperature (tmot), which is specific for the internal combustion engine (10), characterized in that the control arrangement includes means which change a desired value for the position of the throttle flap (18) in the intake manifold (14) in dependence upon the determined temperature (tmot).
